(19) United States
(12) Patent Application Publication
(10) Pub. No.: US 2009/0157488 A1
(43) Pub. Date: Jun. 18, 2009

(54) Work order management system and method

(75) Inventors: Adrian O'Neil, Madison, AL (US); Jason C. Dinkins, Hartselle, AL (US)

Correspondence Address: LANIER FORD SHAVER & PAYNE P.C., P O BOX 2087, HUNTSVILLE, AL, 35804-2087, US

(73) Assignee: Carina Technology, Inc., Huntsville, AL (US)

(21) Appl. No.: 11/955,116

(22) Filed: Dec. 12, 2007

(51) Int. Cl. G06F 17/40; G06Q 10/00

(52) U.S. Cl. 705/11; 705/1; 705/7

(57) ABSTRACT

A work order management system has a work order management application and a web service interface. The system further has a handheld device and logic configured to communicate utility data between the work order management application and the handheld device through the web service interface, wherein the data is indicative of a work order.

### BACKGROUND

Typically, a utility company employs individuals, referred to as utility professionals, who perform a variety of tasks in the field. Such tasks include, but are not limited to, compiling specifications for installing service at a new customer site, installing the hardware for the service at the new customer site, performing maintenance at customer sites, substations, or poles along a power route, repairing damaged hardware during an outage, and the like.

Oftentimes, an operator or dispatcher at the utility company schedules and manages the tasks of a utility professional or a team of utility professionals. As an example, the operator receives information from a team of utility professionals that identifies specifications for installing service for a new customer. The central office takes the identified specifications, and generates a work order on the utility company's work order management application, which is stored in a work order management database. The operator then gives and/or transmits the work order to another team of utility professionals, and the team goes to the new customer site and installs the service.

### SUMMARY OF THE INVENTION

The present disclosure relates to work order management systems and methods. In particular, systems and methods of the present disclosure relate to the use of a handheld device by one or more utility professionals to compile data and transmit the data to a work order management application at a central office or and/or receive data from a work order management application at the central office related to tasks that the utility professional(s) are to perform.

A work order management system in accordance with an embodiment of the present disclosure comprises a work order management application that has a web service interface and a handheld device. In addition, the work order management system comprises logic configured to communicate data between the work order management application and the handheld device through the web service interface, the data indicative of a work order.

A method in accordance with an embodiment of the present disclosure can be conceptualized as comprising the steps of receiving utility data in a web service interface protocol on a handheld device, storing the utility data in memory, and displaying the utility data to a utility professional.

### BRIEF DESCRIPTION OF THE DRAWINGS

The present invention is described with reference to the accompanying drawings. In the drawings, like reference numbers indicate identical or functionally similar elements.

FIG. 1 is a block diagram illustrating a system in accordance with an exemplary embodiment of the present disclosure.

FIG. 2 is a block diagram of an exemplary handheld device as depicted in FIG. 1.

FIG. 3 is a flowchart of exemplary data-collecting architecture and functionality of the handheld device as depicted in FIG. 2.

FIG. 4 is a flowchart of exemplary data-receiving architecture and functionality of the handheld device as depicted in FIG. 2.

### DETAILED DESCRIPTION

Embodiments of the present disclosure generally pertain to work order management systems and methods.

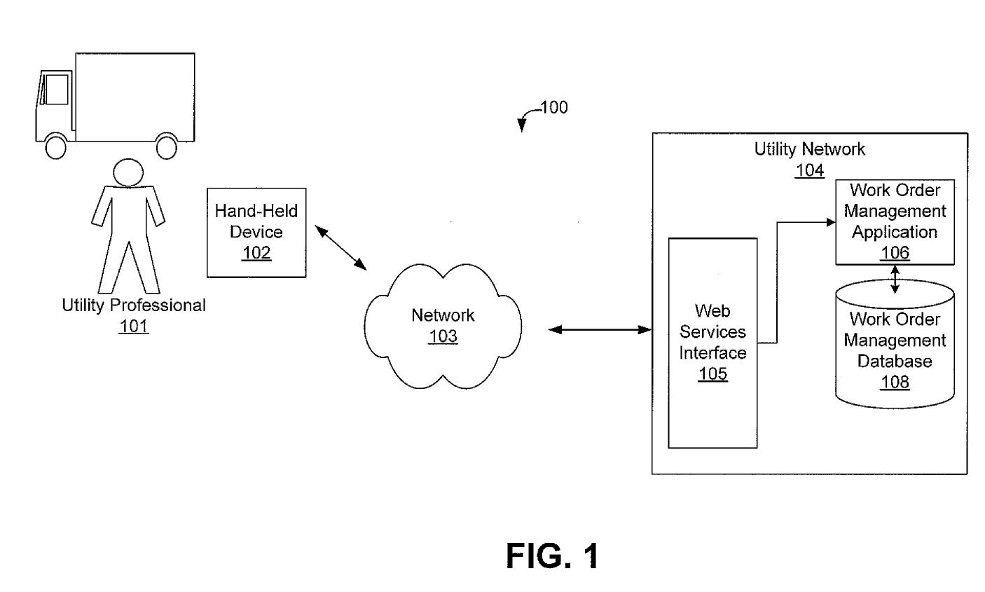

FIG. 1 depicts a work order management system 100 in accordance with an embodiment of the present disclosure. The work order management system 100 comprises a handheld device 102 and a utility network 104 that communicates via a network 103.

The network 103 may be of any type network known in the art, such as Ethernet, analog cellular, digital cellular, short range radio wireless, Wi-Fi, WiMax, broadband over power line, coaxial cable, and the like. Network 103 may be any combination of hardware, software, or both.

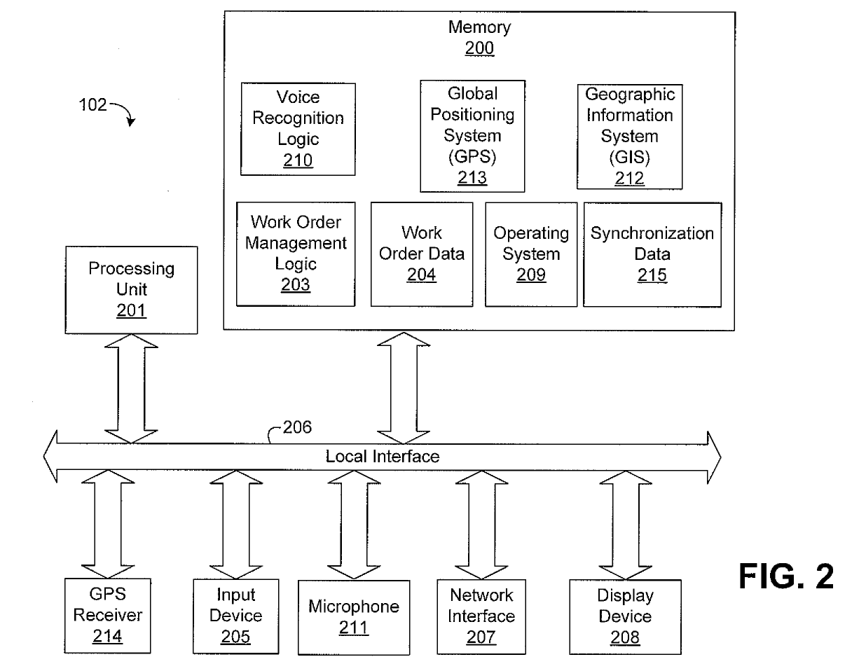

The handheld device 102 can be, for example, a personal digital assistant (PDA). The handheld device 102 comprises software, hardware, or a combination thereof to perform a variety of functions. Such functions may include, for example, wireless voice communications (telephone), internet access, or the like. The handheld device 102 may be stylus-driven, keyboard driven, or voice driven. The handheld device 102 is described further with reference to FIG. 2.

A utility professional 101 is a utility employee in the field who performs utility services, such as, for example, collecting specifications for new service at a customer site (not shown), installing service for a new customer (not shown), performing maintenance at a customer site or at a number of utility facility locations and/or substations in the field, performing operations in the field when an outage occurs, and the like. In performing such services, the utility professional 101 uses the handheld device 102 to enter and/or receive data from the utility network 104 to facilitate his job.

The utility network 104 comprises one or more utility-related applications. In one embodiment, the utility network 104 comprises a work order management application 106. The work order management application 106 may be any number of applications produced from a variety of vendors; however the application 106 includes software generated in accordance with pre-defined specifications of a web service interface (WSI). As examples, Milsoft Utility Solutions, Inc. manufactures an outage management application that uses a WSI, and National Information Solutions Cooperative, Inc., Southeaster Data Cooperative, Inc., and Daffron & Associates, Inc. manufacture work order management applications that use a WSI.

Thus, the utility network 104 also comprises a web services interface (WSI) 105, such as, for example, Multispeak®. Multispeak® is a utility-specific WSI; however, other WSIs are possible in other embodiments of the present disclosure.

Note that Multispeak® is a specification developed specifically for the utility industry to integrate utility applications, such as supervisory control and data acquisition (SCADA), automated meter reading (AMR), outage management (OMS), and IVR. The Multispeak® specification defines how such applications 106, for example, and in particular the software of such applications are integrated based upon Multispeak® so that the application 106 can interoperate without distinct and separate customized interfaces. In an embodiment of the network 104 that employs Multispeak®, real-time messaging is effectuated using a standard protocol.

Via the handheld 102, the utility professional 101 requests a new job. Such request may indicate a location of the utility professional 101 or his team. The handheld 102 transmits a request (not shown) over the network 103 through the WSI 105 from the work order management application 106. The work order management application 105 retrieves the work order from the work order management database 108 and transmits the message through WSI 105 and the network 103 to the handheld device 102. The handheld device 102 displays the work order, and the utility professional 101 proceeds to the next job indicated by the work order.

In one embodiment, the handheld 102 displays a map (not shown) to the utility professional. The map may show the utility professional 101 the directions from the utility professional's current location to the next site based upon the work order received.

In another embodiment, the utility professional 101 may edit the received work order once the job is completed, via the handheld 102. Once the utility professional 101 makes the edits, the utility professional 101 transmits the work order back to the work order management system 106 marked as completed.

FIG. 2 depicts an exemplary handheld device 102 of the present disclosure. The exemplary handheld device 102 generally comprises processing unit 201, display device 208, input device 205, and network interface 207. Each of these components communicates over local bus 206, which can include one or more buses.

Handheld device 102 further comprises work order management logic 203 and work order management data 204. Work order management logic 203 and work order management data 204 can be software, hardware, or a combination thereof. In the exemplary handheld device 102 shown in FIG. 2, work order management logic 203 and work order management data 204 are shown as software stored in memory 200. Memory 200 may be of any type of memory known in the art, including, but not limited to random access memory (RAM), read-only memory (ROM), flash memory, and the like.

As noted hereinabove, work order management logic 203 and work order management data 204 are shown in FIG. 2 as software stored in memory 200. When stored in memory 200, the work order management logic 203 and work order management data 204 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Processing unit 201 may be a digital processor or other type of circuitry configured to run the work order management logic 203 by processing and executing the instructions of the work order management logic 203. By way of example, the processing unit 201 may be an Advanced RISC Machine (ARC) 7, ARC 9, Intel PXA901, or Intel 80386. Note that RISC refers to “Reduced Instruction Set Computer.” The processing unit 201 communicates to and drives the other elements within the handheld device 102 via the local bus 206, which can include one or more buses.

In addition, network interface 207 may be, for example, a radio frequency antenna (RF antenna) or other type of communication device, that connects the handheld device 102 with the network 103 (FIG. 1) for communication with the work order management application 106 via the WSI 105. By way of example, the network interface 207 may be a WI-FI transceiver.

The display device 208 is a device for visually communicating data to the utility professional 101. The display device 208 may be, for example, a backlit liquid crystal display (LCD) screen, which is touch-sensitive for operation with a stylus.

An operating system 209, which may be, for example, Windows Mobile®, may display data to the utility professional 101 via a series of graphical user interfaces (GUIs). The GUIs may comprise a plurality of scalable windows (not shown) that display, for example, data indicative of a work order or trouble ticket to the utility professional 101. Additionally, the display device 208 may display fillable or editable work orders and/or trouble tickets in which the utility professional 101 can enter work order data 204.

Work order data 204 refers to data indicative of details regarding a work order or a trouble ticket, for example, but data 204 can encompass any data that is received and/or transmitted from/to the utility network 104 (FIG. 1) through the WSI 105 (FIG. 1). Such data 204 may include, for example, the address of the customer for which the work is to be performed. The data 204 may further include the customer's name, the type of hardware that may be needed for a particular job, for example a pole needs to be placed, a secondary service needs to be run, or an additional transformer is needed on an existing pole.

Note that the work order data 204 may comprise data entered by the utility professional 101 related to new service, and the utility professional 101 may input this data via the input device 205. On the other hand, the work order data 204 may comprise data transmitted from the work order management application 106 related to the new service that the utility professional 101 is tasked with installing, as an example.

The input device 205 enables the utility professional 101 to enter data into the handheld device 102. In one embodiment, the input device 205 is a keyboard, and the utility professional 101 uses the keyboard to type data into the handheld, which can be stored as work order data 204, described hereinabove. In addition, the display device 208 may be a touch screen (not shown), and the handheld 102 may comprise a stylus (now shown) that the utility professional 101 can used to enter data via the touch screen.

In one embodiment, the handheld 102 may comprise a microphone 211. In such an embodiment, voice recognition logic 210 may be used to capture digitally those words spoken into the microphone 211 by the utility professional 101 related to work order data 204 and stored as work order data 204. In another embodiment, memory 200 stores geographic information system (GIS) logic 212.

During operation, the work order management logic 203 can poll, via the network interface 207, the work order management application 106 (FIG. 1) of the utility network 104 (FIG. 1) to determine whether there is an outstanding work order or trouble ticket that needs servicing. If there is an outstanding ticket, the work order management logic 203 requests download of data indicative of the work order or trouble ticket. Upon receipt, the work order management logic 203 stores the data as work order data 204.

Upon request, or automatically, the work order management logic 203 displays the work order data 204 to the utility professional 101 via the display device 208. Such data may include, for example, the location of the service that is needed, the needed hardware and/or equipment for the service, and the like. The work order management logic 203, may display the data in a GUI to the user, or in any other type of format known in the art or future-developed.

In addition, the utility professional 101 may generate a work order or a trouble ticket. In this regard, the order management logic 203 displays a fillable or editable GUI having a number of fields in which the utility professional 101 can enter data indicative of the work order or trouble ticket. Such information can include, for example, the name of a new or existing customer, the type of hardware and/or equipment needed for the job, service or maintenance being identified by the work order, and a photograph of one or more locations at the site that may need special attention, for example.

In addition, the work order may require a new pole (not shown) or transformer (not shown). In such a situation, the work order management logic 203 can interface with a global positioning system (GPS) 213 stored in memory 200. By way of example, if a pole (not shown) is needed at a particular location at the customer site, the utility professional 101 can locate himself at the particular location, indicate in the editable GUI that a pole is needed and request a GPS location.

The work order management logic 203 interfaces with the GPS 213, which obtains a GPS reading via a GPS receiver 214. The work order management logic 203 then displays data indicative of the location of the utility professional 101 obtained from the GPS 213 in the displayed GUI. Further, once all the information is entered, the utility professional 101 submits the work order to the work order management application 106 via the WSI 105, including the location information of the new pole.

In another embodiment, the work order management logic 203 interfaces with a geographic information system (GIS) 212. In this regard, if the utility professional 101 is sent a work order to a particular address, the work order management logic 203 obtains mapping data from the GIS 212 and displays the mapping location to the utility professional 101 of the site of the work order. Note that the work order management logic 203 may obtain the utility professional's present location from the GPS 210 and using the present location obtain a map from the present location to the location of the new job from the GIS 212.

In another embodiment of the present disclosure, the handheld 102 maintains certain synchronization data 215 resident in memory 200 on the handheld 102. The synchronization data 215 includes currently displayed assembly units, utility professional teams in the field for performing jobs, pricing per assembly unit, ground conditions, and skill set of the utility professionals in the field. The work order management logic 203 transmits automatic and/or periodic messages or manually initiated messages to the work order management application 106 via the WSI 105 to synchronize the data 215 with corresponding data (not shown) in the work order management database 108.

As described hereinabove, a utility professional 101 oftentimes uses the handheld 102 to enter data to generate a new work order. The synchronization data 215 refers to data that the utility professional 101 may use to generate such work orders. As an example, the utility professional may be generating a work order to install service on top of a rocky mountain. “Ground conditions” relates to specific conditions and multiples of base rates based upon specific conditions. Thus, the multiple related to “on top of a rocky mountain” is stored in the work order management database 108. In order to ensure a work order that reflects the currently set multiple for performing work on top of a rocky mountain, the work order management logic 203 on the handheld 102 queries the work order management application 106 and requests synchronization of the handheld work order data 204 with the corresponding data in the database 108 to ensure an accurate price quote or accurate multiple quote related to ground conditions.

The work order management logic 203 may automatically and periodically query the work order management application 106, and during such a query, the work order management logic 203 downloads the synchronization data 215 related to the ground conditions. Thus, when a utility professional 101 desires to indicate a multiple in a work order for ground conditions specific to the job identified by the work order, the data indicative of the multiples related to the ground condition is updated on the handheld 102 and synchronized with the data stored in the work order management database 108.

In addition, the work order management logic 203 can store and keep synchronized other synchronization data 215, as enumerated hereinabove. In this regard, the data 215 may comprises data associated with particular assembly units, i.e., a grouping of electrical components for a utility job, including poles, transformers, conductor sizes, and the like. The synchronization data 215 may include a price per each assembly unit, and the work order management logic 203 would update that data associated with assembly units periodically.

In addition, the work order management logic 203 can store and keep data reflecting the utility professional teams in the field and their skill sets as synchronization data 215. Again, the work order management logic 203 would automatically and periodically update to synchronize the data with the work order management database 108.

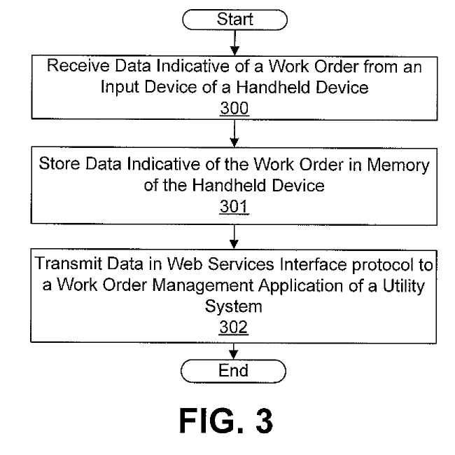

FIG. 3 is a flowchart depicting exemplary data-collecting architecture and functionality of the work order management logic 203 (FIG. 2).

In step 300, the work order management logic 203 receives data indicative of a work order via a handheld device 102 (FIG. 1). In one embodiment, the data received is entered via a keyboard (not shown), and in another embodiment, the utility professional 101 (FIG. 1) can enter the data via a plurality of pull-down menus (not shown) using a stylus (not shown) and a touch screen (not shown), for example. The work order management logic 203 may receive the data through a GUI (not shown) or through a microphone 211 (FIG. 2).

In step 301, the work order management logic 203 stores the received data as work order data 204. Note that work order data 204 is a term that can be used to refer to any data that is entered into the handheld 102 by the utility professional 101 that the work order management logic 203 stores for future access. Such work order data 204 (FIG. 2) may include, for example, also data related to trouble tickets.

In step 302, the work order management logic 203 transmits word order data 204 in a WSI protocol to the work order management application 106 (FIG. 1) of a utility network 104 (FIG. 1). Transmitting in the WSI protocol ensures that the work order management application logic 203 transmits data to the work order management logic 203 that is portable to any platform, operating system, or other system characteristic of the application 106.

In one embodiment, the work order management application 106 stores the work order data 204 in the work order management database 108. The work order data 204 can then be retrieved by another utility professional 101 when the work evidenced by the work order data 204 is to be done.

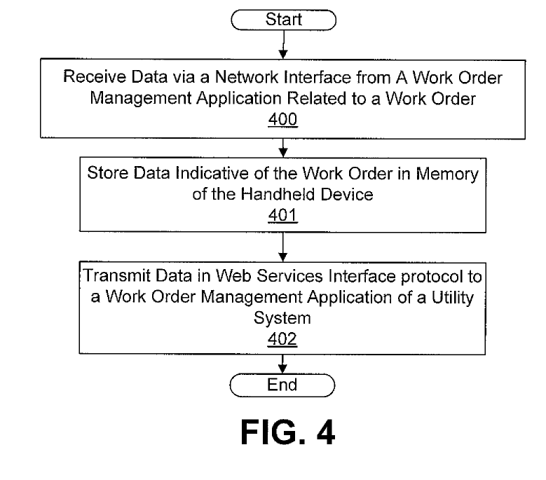

FIG. 4 is a flowchart depicting exemplary data-receiving architecture and functionality of the work order management logic 203 (FIG. 2).

In step 400, the work order management logic 203 receives data indicative of a work order via a network interface 207 (FIG. 2) of the handheld device 102 (FIG. 1). In one embodiment, the work order management logic 203 periodically polls to determine if there is an open work order for the associated utility professional 101.

In step 401, the work order management logic 203 stores the received data as work order data 204 (FIG. 2). Note that work order data 204 is a term that can be used to refer to any data that is received by the handheld 102 from the work order management application 106 or entered via the handheld 102 and the work order management logic 203 related to work order management.

In step 402, the work order management logic 203 displays the work order data 204 to the display device 208 (FIG. 2) of the handheld 102. The utility professional 101 can use the displayed work order data 204 to facilitate the job indicated in the displayed work order data 204.

What is claimed is:

1. A work order management system, comprising:
a work order management application having a web service interface;
a handheld device; and
logic configured to communicate utility data between the work order management application and the handheld device through the web service interface, the data indicative of a work order.

2. The work order management system of claim 1, wherein the web service interface is Multispeak®.

3. The work order management system of claim 1, wherein the handheld device comprises a data input device, and the logic is further configured to receive new service data from the data input device and communicate the new service data to the work order management application.

4. The work order management system of claim 3, wherein the work order management application is configured to schedule a new service work order based upon the new service data.

5. The work order management system of claim 4, wherein the work order management application is configured to transmit data indicative of the new service work order to the handheld device.

6. The work order management system of claim 1, wherein the logic is further configured to display an editable graphical user interface (GUI) for receiving information related to a utility work order.

7. The work order management system of claim 6, wherein the logic is further configured to determine a global positioning system (GPS) location for a particular component related to the utility work order.

8. The work order management system of claim 7, wherein the logic is further configured to display data indicative of the location in the editable GUI.

9. The work order management system of claim 7, wherein the logic is further configured to transmit the location associated with the component to the work order management application.

10. The work order management system of claim 1, wherein the logic is further configured to received data indicative of a work order and transmit the data indicative of the work order to the work order management application in a WSI protocol.

11. The work order management system of claim 1, wherein the logic is further configured to determine a location of the handheld device and retrieve a map indicating a route from the location of the handheld to a new location identified in a work order received from the work order management application.

12. The work order management system of claim 1, wherein the logic is further configured to store dynamic data in resident memory and periodically poll the work order management system to determine if the associated data has been modified.

13. The work order management system of claim 12, wherein the logic is further configured to update the dynamic data in resident memory based upon the periodic polling.

14. The work order management system of claim 12, wherein the dynamic data comprises data indicative of ground conditions, skill set of a utility professional, price of an assembly unit, or utility professionals and corresponding actions.

15. A work order management method, comprising:
receiving utility data in a web service interface protocol on a handheld device;
storing the utility data in memory; and
displaying the utility data to a utility professional.

16. The work order management method of claim 15, wherein the receiving step comprise receiving utility data in Multispeak® specification.

17. The work order management method of claim 15, further comprising the steps of:
receiving new service data from a data input device; and
communicating the new service data to the work order management application.

18. The work order management method of claim 17, further comprising the step of scheduling a new service work order based upon the new service data.

19. The work order management method of claim 18, further comprising the step of transmitting data indicative of the new service work order to the handheld device.

20. The work order management method of claim 15, further comprising the step of displaying an editable graphical user interface (GUI) for receiving information related to a utility work order.

21. The work order management method of claim 20, further comprising the step of determining a global positioning system (GPS) location for a particular component related to the utility work order.

22. The work order management method of claim 21, further comprising the step of displaying data indicative of the location in the editable GUI.

23. The work order management method of claim 21, further comprising the step of transmitting the location associated with the component to the work order management application.

24. The work order management method of claim 15, wherein further comprising the steps of:
receiving data indicative of a work order; and
transmitting the data indicative of the work order to the work order management application in a WSI protocol.

25. The work order management method of claim 15, further comprising the steps of:
determining a location of the handheld device; and
retrieving a map indicating a route from the location of the handheld to a new location identified in a work order received from the work order management application.

26. The work order management method of claim 15, further comprising the steps of:
storing dynamic data in resident memory; and
periodically polling the work order management system to determine if the associated data has been modified.

27. The work order management method of claim 26, further comprising the step of updating the dynamic data in resident memory based upon the periodic polling.

28. The work order management method of claim 26, wherein the dynamic data comprises data indicative of ground conditions, skill set of a utility professional, price of an assembly unit, or utility professionals and corresponding actions.
